(19) United States
(12) Patent Application Publication
(10) Pub. No.: US 2020/0198602 A1
(43) Pub. Date: Jun. 25, 2020

(54) CONTROL DEVICE FOR VEHICLE AND VEHICLE INCLUDING CONTROL DEVICE

(71) Applicant: TOYOTA JIDOSHA KABUSHIKI KAISHA, Toyota-shi (JP)

(72) Inventor: Kuniaki ISHII, Toyota-shi (JP)

(73) Assignee: TOYOTA JIDOSHA KABUSHIKI KAISHA, Toyota-shi (JP)

(21) Appl. No.: 16/701,402

(22) Filed: Dec. 3, 2019

(30) Foreign Application Priority Data
Dec. 21, 2018 (JP) 2018-240298

(51) Int. Cl. B60T 8/17; B60T 7/12; B60T 13/62; B60T 13/74

(52) U.S. Cl. CPC B60T 8/17; B60T 7/12; B60T 2220/00; B60T 13/74; B60T 2210/20; B60T 13/62

(57) ABSTRACT

A control device for a vehicle including a first brake device that applies a braking force to vehicle wheels in response to a driver's operation of a brake, a second brake device that applies a braking force to the vehicle wheels through an electric actuator when a shifting operation position is switched to a parking position, and a parking lock mechanism that stops rotation of the vehicle wheels by stopping rotation of a parking gear interlocking with the vehicle wheels when the shifting operation position is switched to the parking position. The control device includes an electronic control unit configured to maintain an operating state of the first brake device until the braking force is applied to the vehicle wheels by the second brake device when the shifting operation position is switched to the parking position after the first brake device has been operated by the driver.

### INCORPORATION BY REFERENCE

The disclosure of Japanese Patent Application No. 2018-240298 filed on Dec. 21, 2018 including the specification, drawings and abstract is incorporated herein by reference in its entirety.

### BACKGROUND

### 1. Technical Field

The disclosure relates to a control device for a vehicle and particularly to suppression of a shock which is generated when a parking position is switched to another position. The disclosure also relates to a vehicle including the control device.

### 2. Description of Related Art

A technique of automatically holding a foot brake and maintaining a braking force of the foot brake until a shifting operation position is switched from a parking position to another position (hereinafter referred to as a “non-parking position”) when an inclination angle of a sloping road is greater than a predetermined value has been proposed. An example of a vehicle with such a technique is described in Japanese Patent Application Publication No. 2009-120066 (JP 2009-120066 A). Since torsion of a drive shaft is curbed by automatically maintaining the foot brake, a shock which is generated when the shifting operation position is switched from a parking position to a non-parking position the next time a vehicle is started is suppressed.

### SUMMARY

In JP 2009-120066 A, since automatic maintenance of the foot brake is performed using a hydraulic brake, energy which is consumed to maintain a brake oil pressure increases. On the other hand, when an electric parking brake described in Japanese Patent No. 4147253 is used, a braking force is mechanically given to vehicle wheels and energy which is consumed to maintain a braking force decreases. However, since an electric parking brake has poorer responsiveness than a hydraulic brake, a time in which a braking force is not given to vehicle wheels is present when a driver releases a foot brake until a braking force is given by the electric parking brake. At this time, since the vehicle wheels rotate to twist a drive shaft, a shock may be generated when a shifting operation position is switched to a non-parking position the next time the vehicle is started.

The disclosure provides a control device that can suppress a shock which is generated when a shifting operation position is switched from a parking position to a non-parking position in a vehicle including an electric parking brake.

According to an aspect of the disclosure, there is provided a control device for a vehicle. The vehicle includes a first brake device that applies a braking force to vehicle wheels in response to a driver's operation of a brake, a second brake device that applies a braking force to the vehicle wheels through an electric actuator when a shifting operation position is switched to a parking position, and a parking lock mechanism that stops rotation of the vehicle wheels by stopping rotation of a parking gear interlocking with the vehicle wheels when the shifting operation position is switched to the parking position. The control device includes an electronic control unit configured to maintain an operating state of the first brake device until a braking force is applied to the vehicle wheels by the second brake device when the shifting operation position is switched to the parking position after the first brake device has been operated by the driver.

According to this configuration, even when operation of the first brake device has been rapidly released by a driver after the shifting operation position has been switched to the parking position, a braking force from the first brake device is maintained. Accordingly, rotation of the vehicle wheels is curbed and torsion of a rotation member that connects the vehicle wheels and the parking gear is suppressed. As a result, when the shifting operation position is switched from the parking position to a non-parking position at the time of starting of the vehicle, a shock which is generated due to torsion of the rotation member is suppressed.

In the control device for a vehicle according to the aspect, the electronic control unit may be configured to determine whether a predetermined time has elapsed from a time point at which operation of the second brake device has started and to maintain an operating state of the first brake device when the electronic control unit determines that the predetermined time has not elapsed from the time point at which the operation of the second brake device has started.

The control device for a vehicle according to the aspect may further include a road gradient detecting unit that detects a road gradient, and the electronic control unit may be configured to determine whether the detected road gradient is equal to or greater than a predetermined value and to operate the second brake device when the electronic control unit determines that the detected road gradient is equal to or greater than the predetermined value and the shifting operation position is switched to the parking position.

According to this configuration, when the road gradient is equal to or greater than the predetermined value and the shifting operation position is switched to the parking position, the second brake device operates. Accordingly, by causing the second brake device to operate only on a road gradient on which torsion of the rotation member connecting the vehicle wheels and the parking gear is likely to occur and causing the second brake device not to operate on a road gradient on which torsion of the rotation member is not likely to occur, the number of operations of the second brake device decreases and durability of the second brake device is improved.

In the control device for a vehicle according to the aspect, the road gradient detecting unit may be an acceleration sensor.

According to this configuration, by detecting a road gradient from acceleration which is detected by an existing acceleration sensor, it is not necessary to add a new sensor for detecting a road gradient.

In the control device for a vehicle according to the aspect, the vehicle may be an electric vehicle.

According to this configuration, since the vehicle is an electric vehicle, a shock which is generated due to torsion of the rotation member between the vehicle wheels and the parking gear is likely to become greater than that in a vehicle including an engine when the shifting operation position is switched to a non-parking position at the time of starting of the vehicle. Accordingly, a shock suppressing effect which is obtained by maintaining the operating state of the first brake device to curb torsion of the rotation member becomes marked.

According to another aspect of the disclosure, there is provided a vehicle including: a first brake device that applies a braking force to vehicle wheels in response to a driver's operation of a brake; a second brake device that applies a braking force to the vehicle wheels through an electric actuator when a shifting operation position is switched to a parking position; a parking lock mechanism that stops rotation of the vehicle wheels by stopping rotation of a parking gear interlocking with the vehicle wheels when the shifting operation position is switched to the parking position; and an electronic control unit configured to maintain an operating state of the first brake device until a braking force is applied to the vehicle wheels by the second brake device when the shifting operation position is switched to the parking position after the first brake device has been operated by the driver.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram schematically illustrating a configuration of a vehicle to which the disclosure is applied and illustrating principal parts of a control system which is provided in the vehicle;

FIG. 2 is a perspective view schematically illustrating a structure of a parking lock mechanism illustrated in FIG. 1;

FIG. 3 is a functional block diagram illustrating principal parts of a control operation of an electronic control unit illustrated in FIG. 1; and

FIG. 4 is a flowchart illustrating principal parts of a control operation of the electronic control unit illustrated in FIG. 3, that is, a control operation when a shifting operation position is switched to a parking position after a vehicle is stopped or reaches a very low speed through depression of a brake pedal.

### DETAILED DESCRIPTION OF EMBODIMENTS

Hereinafter, an embodiment of the disclosure will be described in detail with reference to the accompanying drawings. In the following embodiment, the drawings are appropriately simplified or modified and dimensional ratios and shapes of elements and the like are not necessarily accurate.

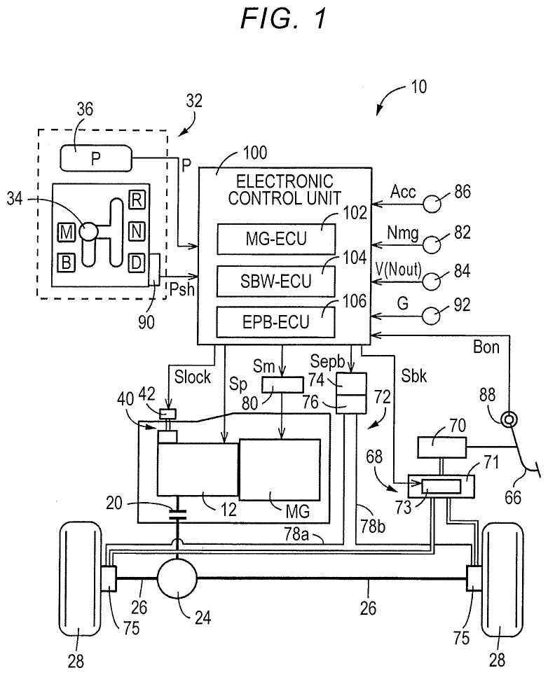

FIG. 1 is a diagram schematically illustrating a configuration of a vehicle 10 to which the disclosure is applied and illustrating principal parts of a control system which is provided in the vehicle 10. The vehicle 10 is an electric vehicle that travels using a traveling motor MG as a driving power source. The vehicle 10 includes the traveling motor MG which is a travel driving power source and a power transmission unit 12 that transmits power of the traveling motor MG to an output gear 20 which is an output rotation member. Power which is generated by the traveling motor MG passes through the power transmission unit 12 and is transmitted to right and left vehicle wheels 28 sequentially via the output gear 20, a differential gear unit 24, and a pair of drive shafts 26 (axles) of the power transmission unit 12, and the like.

In the vehicle 10, a shift-by-wire system in which a shift range of the power transmission unit 12 is electrically switched based on a signal indicating a shifting operation position Psh corresponding to an operation position of a shift lever 34 of a shifting operation device 32 illustrated in FIG. 1 and a signal indicating whether a P switch 36 has been operated (that is, a signal indicating switching of the shifting operation position Psh to a parking position P) is employed. The shift lever 34 is configured to be switched to, for example, a drive position D which is a forward traveling position, a reverse position R which is a backward traveling position, a neutral position N at which transmission of power is cut off, and a brake position B at which a braking force is generated by regeneration. It is assumed that the shifting operation positions Psh include a parking position P in addition to the positions (D, R, N, and B) which are selected by the shift lever 34.

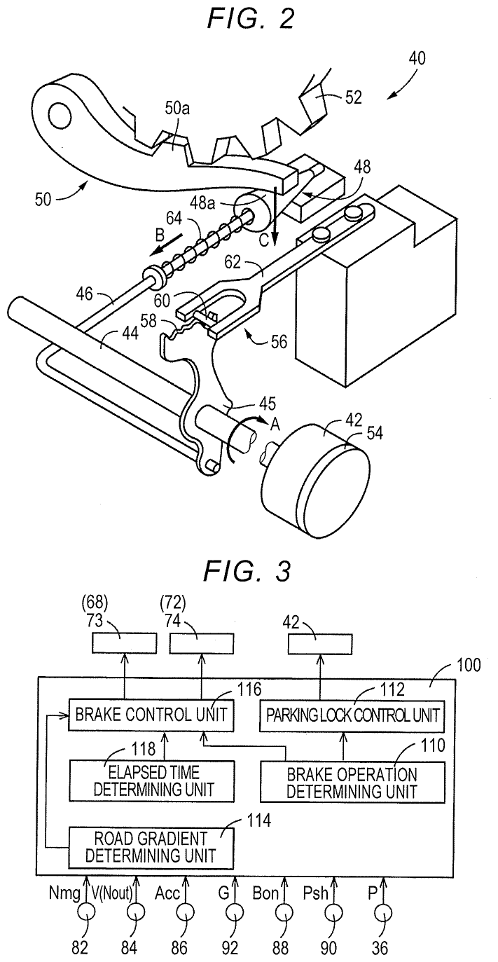

In the power transmission unit 12, the P switch 36 of the shifting operation device 32 is pressed by a driver. That is, a parking lock mechanism 40 that operates when the shifting operation position Psh is switched to the parking position P, prevents rotation of vehicle wheels 28 by stopping rotation of a parking gear 52 (see FIG. 2) interlocking with the vehicle wheels 28, and switches the power transmission unit 12 to a parking range which is a vehicle parking range is provided.

FIG. 2 is a perspective view schematically illustrating a structure of the parking lock mechanism 40. The parking lock mechanism 40 includes a stepping motor 42 that operates based on the shifting operation position Psh which is selected by the shift lever 34 of the shifting operation device 32, a shaft 44 that is rotated by the stepping motor 42, a detent plate 45 that is connected to the shaft 44 and rotates in accordance with a rotational position of the shaft 44, a parking rod 46 that is connected to the detent plate 45, a cam member 48 that is provided at a tip of the parking rod 46, a parking pole 50 that comes in contact with the cam member 48, and a parking gear 52 that is able to engage with an engagement tooth 50a which is provided in the parking pole 50. A rotational position of the stepping motor 42 is frequently detected by a rotary encoder 54.

The detent plate 45 is constituted by a plate-shaped member and rotates with rotation of the shaft 44. A cam surface 58 constituting a detent mechanism 56 (a detent) is provided in the detent plate 45. The detent mechanism 56 includes the cam surface 58, an engagement roller 60 that comes in contact with the cam surface 58, and a detent spring 62 that generates a biasing force for pressing the engagement roller 60 to the cam surface 58. The cam surface 58 is formed in a wave shape and a plurality of depressions is formed thereon. By allowing the engagement roller 60 to fall and enter one of the plurality of depressions, the detent plate 45 is positioned at a rotational position which is preset for each shift range.

One end of the parking rod 46 is connected to a side of the detent plate 45 opposite to the side on which the cam surface 58 is provided with the shaft 44 interposed therebetween. Accordingly, when the shaft 44 rotates in a direction of arrow A in FIG. 1, the detent plate 45 rotates in the same direction as the shaft 44. At this time, the other end of the parking rod 46 moves in a direction of arrow B. On the other hand, when the shaft 44 rotates in the direction opposite to arrow A, the detent plate 45 also rotates in the same direction as the shaft 44. At this time, the other end of the parking rod 46 moves in the direction opposite to arrow B.

The cam member 48 is inserted into the other end of the parking rod 46 and biased toward the other end of the parking rod 46 by the detent spring 64. The cam member 48 is formed in a conical shape and an inclined surface 48a is formed on the other circumference side. The parking pole 50 comes in contact with the inclined surface 48a. The parking pole 50 is formed in a rectangular shape and a side of the parking pole 50 opposite to the side in contact with the inclined surface 48a of the cam member 48 is able to rotate. Accordingly, by changing the position of the inclined surface 48a of the cam member 48 in contact with the parking pole 50, the parking pole 50 rotates.

For example, when the cam member 48 that is provided at the other end of the parking rod 46 moves in the direction of arrow B, a contact position between the parking pole 50 and the cam member 48 moves to a small-diameter side of the cam member 48 and the parking pole 50 rotates in a direction of arrow C. At this time, the engagement tooth 50a provided on the side of the parking pole 50 facing the parking gear 52 and the parking gear 52 are disengaged from each other and thus the parking gear 52 is able to rotate. On the other hand, when the cam member 48 rotates in the direction opposite to arrow B, the contact position of the parking pole 50 with the cam member 48 moves to a large-diameter side of the cam member 48 and the parking pole 50 rotates in the direction opposite to arrow C. At this time, the engagement tooth 50a of the parking pole 50 engages with the parking gear 52 and rotation of the parking gear 52 stops. Since rotation of the vehicle wheels 28 interlocking with the parking gear 52 is stopped, the shift range of the power transmission unit 12 is switched to the parking range.

In the parking lock mechanism 40 having the above-mentioned configuration, when the P switch 36 of the shifting operation device 32 is pressed by the driver, the stepping motor 42 operates, and the stepping motor 42 and the shaft 44 rotate to a preset rotational position corresponding to the parking range in the direction opposite to arrow A. At this time, the other end of the parking rod 46 moves in the direction opposite to arrow B and the cam member 48 provided at the other end of the parking rod 46 moves in the direction opposite to arrow B. Accordingly, the position of the inclined surface 48a of the cam member 48 in contact with the parking pole 50 moves to the large-diameter side of the cam member 48 and the parking pole 50 rotates in the direction opposite to arrow C. Accordingly, the engagement tooth 50a of the parking pole 50 engages with the parking gear 52 and thus the shift range of the power transmission unit 12 is switched to the parking range.

On the other hand, when the shifting operation position Psh is switched to a position (a non-parking position) other than the parking position P, the stepping motor 42 and the shaft 44 rotate in the direction of arrow A and rotate to the rotational position corresponding to the selected shifting operation position Psh. At this time, the other end of the parking rod 46 and the cam member 48 move in the direction of arrow B, the position of the inclined surface 48a of the cam member 48 in contact with the parking pole 50 moves to the small-diameter side of the cam member 48, and the parking pole 50 rotates in the direction of arrow C. Accordingly, the engagement tooth 50a of the parking pole 50 and the parking gear 52 are disengaged from each other and the shift range of the power transmission unit 12 is switched from the parking range to another shift range.

Referring back to FIG. 1, the vehicle 10 includes a foot brake device 68 that is operated by a driver's depression of a brake pedal 66 and applies a braking force to the vehicle wheels 28. The foot brake device 68 includes a master cylinder 70, a brake actuator 71, and a wheel brake 75 that is provided in each vehicle wheel 28. When the brake pedal 66 is depressed by a driver, a depression force on the brake pedal 66 is converted into a brake oil pressure by the master cylinder 70 and the converted brake oil pressure is supplied to the wheel brakes 75 via the brake actuator 71. Each wheel brake 75 includes a hydraulic wheel cylinder which is not illustrated, the brake oil pressure is supplied to the wheel cylinder to operate the wheel brake 75, and a braking force proportional to the brake oil pressure is applied to the vehicle wheel 28. The foot brake device 68 corresponds to a first brake device in the disclosure.

The brake actuator 71 includes, for example, a hydraulic pump or an accumulator and a plurality of solenoid valves 73 that can regulate the brake oil pressure of the wheel brake 75 provided in each vehicle wheel 28, can supply the regulated brake oil pressure to the wheel brake 75 in accordance with a command form an electronic control unit 100 which will be described later, and can apply a braking force to the vehicle wheel 28. In this way, the foot brake device 68 can apply a brake force to the vehicle wheels 28 by controlling the brake oil pressure in addition to a driver's operation of a brake such that the wheel brakes 75 are operated.

The vehicle 10 includes an electric parking brake 72 that operates by interlocking with the parking lock mechanism 40 when the P switch 36 of the shifting operation device 32 is pressed and the shifting operation position Psh is switched to the parking position P. The electric parking brake 72 corresponds to a second brake device in the disclosure.

The electric parking brake 72 includes an electric motor 74, a cable retractor 76 that is driven by the electric motor 74, and a pair of parking brake cables 78a and 78b (hereinafter referred to as cables 78) that connects the cable retractor 76 to the wheel brakes 75. When the P switch 36 is pressed, the electric motor 74 rotates in one direction, the cables 78 are retracted by the cable retractor 76, and tensions of the cables 78 increase. At this time, parking brake shoe levers that are provided in the wheel brakes 75 and are operatively connected to the cables 78 are operated, the wheel brakes 75 are operated, and a braking force is applied to the vehicle wheels 28. In this way, in the electric parking brake 72, when the P switch 36 of the shifting operation device 32 is pressed and the shifting operation position Psh is switched to the parking position P, the cables 78 are retracted via the electric motor 74 and the cable retractor 76, the wheel brakes 75 are operated, and a braking force is applied to the vehicle wheel 28.

The cable retractor 76 is configured to mechanically maintain the tensions of the cables 78 when the electric motor 74 rotates to a predetermined position. Accordingly, even after the power transmission unit 12 is switched to the parking range, the braking force from the electric parking brake 72 to the vehicle wheels 28 is mechanically maintained. When the shifting operation position Psh is switched to a non-parking position, the electric motor 74 rotates reversely, retraction of the cables 78 by the cable retractor 76 is released, the tensions of the cables 78 decrease, and the operation of the wheel brakes 75 is released. An electric actuator in the disclosure is constituted by the electric motor 74 and the cable retractor 76.

The vehicle 10 includes the electronic control unit 100 that executes various controls in the vehicle 10. The electronic control unit 100 includes a plurality of so-called microcomputers including a CPU, a ROM, a RAM, and an input and output interface, and performs drive control of the traveling motor MG; switching of the shift range of the power transmission unit 12, and operation of the electric parking brake 72 by performing signal processing in accordance with a program stored in advance in the ROM while using a temporary storage function of the RAM. The electronic control unit 100 includes a plurality of ECUs such as an MG0ECU 102 that controls the output of the traveling motor MG; an SBW-ECU 104 that controls switching of the shift range of the power transmission unit 12, and an EPB-ECU 106 that controls operation of the electric parking brake 72.

The electronic control unit 100 is supplied with, for example, a signal indicating a motor rotation speed Nmg (rpm) which is a rotation speed of the traveling motor MG which is detected by a motor rotation speed sensor 82, a signal indicating an output rotation speed Nout which is a rotation speed of the output gear 20 corresponding to a vehicle speed V which is detected by a vehicle speed sensor 84, a signal indicating an accelerator operation amount Acc (%) which is an amount of operation of an accelerator pedal which is detected by an accelerator operation amount sensor 86, a signal Bon indicating whether the brake pedal 66 has been operated, which is detected by a brake switch 88, a signal indicating the shifting operation position Psh of the shift lever 34 which is detected by a shift position sensor 90 constituting a shifting operation device 32, a signal indicating pressing of the P switch 36, that is, a signal indicating switching to the parking position P, and a signal indicating a vehicle longitudinal acceleration G which is detected by a G sensor 92 (an acceleration sensor).

For example, a motor output command signal Sm to an inverter 80 for drive control of the traveling motor MG; a shift switching command signal Sp for switching the shift range of the power transmission unit 12, a parking lock command signal Slock for controlling the operation of the parking lock mechanism 40, a brake command signal Sbk for controlling a brake oil pressure supplied to the wheel brakes 75 such that the operation of the foot brake device 68 is controlled, and an electric parking brake command signal Sepb for controlling the operation of the electric parking brake 72 are output from electronic control unit 100.

In the vehicle 10 having the above-mentioned configuration, the vehicle 10 is decelerated when the brake pedal 66 is depressed during traveling, and when the P switch 36 is pressed in a state in which the vehicle 10 is in a stopped state or a very low vehicle-speed state, the parking lock mechanism 40 is operated and the engagement tooth 50a of the parking pole 50 engages with the parking gear 52 to switch to the parking range. When the P switch 36 is pressed, the electric parking brake 72 operates along with the parking lock mechanism 40 and thus a braking force is applied to the vehicle wheels 28. Since a braking force is applied to the vehicle wheels 28 by the electric parking brake 72 in this way, torsion of the drive shaft 26 constituting power transmission paths between the vehicle wheels 28 and the parking gear 52 is suppressed due to rotation of the vehicle wheels 28 based on the weight of the vehicle 10 and a road gradient L even when the vehicle 10 stops on an uphill road.

In this regard, at the time of next starting of the vehicle, the shifting operation position Psh is switched from the parking position to a non-parking position (for example, a drive position) in a state in which the brake pedal 66 is depressed. When engagement between the engagement tooth 50a of the parking pole 50 and the parking gear 52 is released, a torque (hereinafter referred to as a torsion torque) which is generated by releasing torsion of the drive shafts 26 is transmitted to the power transmission unit 12 side, and a shock which is generated by shaking of the vehicle 10 due to the torsion torque is suppressed.

However, when a driver rapidly releases depression of the brake pedal 66 after pressing the P switch 36, a braking force due to the foot brake device 68 disappears and a period in which no braking force is applied to the vehicle wheels 28 is formed. When the vehicle wheels 28 rotate to twist the drive shafts 26 in the meantime, there is concern that a shock will be generated at the time of starting of the vehicle. Here, when the P switch 36 is pressed, the electric parking brake 72 operates, but since the electric parking brake 72 has poorer responsiveness and requires a more time for operation in comparison with a hydraulic brake, the drive shafts 26 are twisted until a braking force is applied to the vehicle wheels 28 by the electric parking brake 72.

In order to curb torsion of the drive shafts 26, torsion of the drive shafts 26 in the vehicle 10 is curbed by maintaining the operating state of the foot brake device 68 and maintaining a state in which a braking force is applied to the vehicle wheels 28 by the foot brake device 68 until a braking force is applied to the vehicle wheels 28 by the electric parking brake 72, even when depression of the brake pedal 66 is released when the shifting operation position Psh is switched to the parking position P after the foot brake device 68 has been operated by a driver. Hereinafter, control when the shifting operation position Psh is switched to the parking position P by pressing the P switch 36 after the vehicle 10 has entered a stopped state or a very low-speed state through depression of the brake pedal 66 will be described.

FIG. 3 is a block diagram illustrating principal parts of a control operation of the electronic control unit 100 when the shifting operation position Psh is switched to the parking position P after the vehicle 10 has entered the stopped state or the very low-speed state in response to a driver's operation of the foot brake device 68. The electronic control unit 100 functionally includes a brake operation determining unit 110, a parking lock control unit 112, a road gradient determining unit 114, a brake control unit 116, and an elapsed time determining unit 118. Hereinafter, control functions of the control units will be described.

The brake operation determining unit 110 determines whether the foot brake device 68 has operated in response to a driver's depression of the brake pedal 66. The brake operation determining unit 110 determines the operation of the foot brake device 68 based on a signal Bon indicating whether the brake pedal 66 has operated, which is detected by the brake switch 88. When the foot brake device 68 has operated, a braking force is applied to the vehicle wheels 28 and the vehicle 10 decelerates.

The parking lock control unit 112 determines whether the shifting operation position Psh has been switched to the parking position P when the P switch 36 is pressed by a driver after the vehicle 10 has decelerated and entered the stopped state or the very low-speed state. When it is determined that the shifting operation position Psh has been switched to the parking position P, the parking lock control unit 112 causes the engagement tooth 50a of the parking pole 50 and the parking gear 52 to engage with each other and switches the shift range of the power transmission unit 12 to the parking range by operating the parking lock mechanism 40.

The road gradient determining unit 114 determines whether a road gradient L is equal to or greater than a predetermined value α which is set in advance. The road gradient determining unit 114 estimates the road gradient L from a vehicle longitudinal acceleration G which is frequently detected by the G sensor 92. The road gradient determining unit 114 estimates the road gradient L by applying a reference acceleration Gst when the vehicle travels on a level road and a vehicle longitudinal acceleration G which is frequently detected by the G sensor 92 to a preset relationship expression for calculating the road gradient L, which includes the reference acceleration Gst and the vehicle longitudinal acceleration G The reference acceleration Gst is a value which is calculated and stored by experiment or design in advance. The road gradient L is detected from the vehicle longitudinal acceleration G which is frequently detected until the vehicle 10 has stopped. The G sensor 92 corresponds to a road gradient detecting unit and an acceleration sensor in the disclosure.

When the road gradient L is detected, the road gradient determining unit 114 determines whether the road gradient L (an absolute value) is equal to or greater than the predetermined value α. The predetermined value α is acquired by experiment or design in advance and is set to, for example, a threshold value with which the vehicle wheels 28 are rotated by the weight of the vehicle 10 and the road gradient L and the drive shafts 26 are twisted when switching to the parking range has been performed.

When it is determined that the road gradient L is equal to or greater than the predetermined value α and the shifting operation position Psh is switched to the parking position P, the brake control unit 116 operates the electric parking brake 72 to apply a braking force to the vehicle wheels 28. On the other hand, when it is determined that the road gradient L is less than the predetermined value α, the brake control unit 116 may not operate the electric parking brake 72 even when the shifting operation position Psh is switched to the parking position P. This is because, when the road gradient L is less than the predetermined value α, the vehicle wheels 28 do not rotate without operating the electric parking brake 72 and the drive shafts 26 are not twisted in this regard.

When the shifting operation position Psh is switched to the parking position P, the brake operation determining unit 110 determines whether depression of the brake pedal 66 has been released. When the brake operation determining unit 110 determines that depression of the brake pedal 66 has been released, the brake control unit 116 controls the solenoid valves 73 provided in the brake actuator 71 such that the operating state of the foot brake device 68 is maintained. Accordingly, even when depression of the brake pedal 66 is released until a braking force is applied to the vehicle wheels 28 by operating the electric parking brake 72, the braking force applied to the vehicle wheels 28 by the foot brake device 68 is maintained and thus torsion of the drive shafts 26 due to rotation of the vehicle wheels 28 is curbed.

The elapsed time determining unit 118 determines whether a predetermined time β which is set in advance has elapsed from a time point (an operation start time point) at which operation of the electric parking brake 72 has started. The predetermined time β is acquired by experiment or design in advance and is set to a time which is required until a braking force is applied to the vehicle wheels 28 by the electric parking brake 72 from the operation start time point of the electric parking brake 72. That is, the predetermined time β is set to a time in which a response delay of the electric parking brake 72 is reflected.

When the elapsed time determining unit 118 determines that the predetermined time β has not elapsed from the operation start time point of the electric parking brake 72, the brake control unit 116 maintains the operating state of the foot brake device 68. Accordingly, by maintaining the operating state of the foot brake device 68 and applying a braking force from the foot brake device 68 to the vehicle wheels 28 until a braking force is applied to the vehicle wheels 28 by the electric parking brake 72, it is possible to curb rotation of the vehicle wheels 28 and to curb torsion of the drive shafts 26. On the other hand, when the elapsed time determining unit 118 determines that the predetermined time β has elapsed from the operation start time point of the electric parking brake 72, the brake control unit 116 releases the operation of the foot brake device 68. As a time point at which the predetermined time β has elapsed, since a braking force is applied to the vehicle wheels 28 by the electric parking brake 72, rotation of the vehicle wheels 28 is curved even when the operation of the foot brake device 68 is released. Since it is not necessary to maintain the brake oil pressure at a high pressure by releasing the operation of the foot brake device 68, it is possible to reduce energy which is consumed in maintaining the brake oil pressure. In the electric parking brake 72, when the electric motor 74 rotates to a rotational position at which a braking force is applied to the vehicle wheels 28, the tensions of the cables 78 are mechanically maintained by the cable retractor 76 even when supply of electric power to the electric motor 74 is stopped. Accordingly, the braking force from the electric parking brake 72 to the vehicle wheels 28 is maintained until the vehicle starts in the next time without an energy loss.

Accordingly, at the time of next starting of the vehicle, the shifting operation position Psh is switched from the parking position P to, for example, the drive position D in a state in which the brake pedal 66 is depressed. At this time, since torsion of the drive shafts 26 is curbed, a torsion torque which is generated when the torsion of the drive shafts 26 is released is transmitted to the power transmission unit 12 and a shock which is generated by shaking of the vehicle 10 due to the torsion torque is suppressed. Particularly, since the vehicle 10 is an electric vehicle and thus does not include a component having a large mass such as an engine, shaking of the vehicle 10 when the torsion torque is transmitted to the power transmission unit 12 side is large and a shock is likely to increase. On the other hand, by executing the above-mentioned control, the torsion of the drive shafts 26 is curbed and a shock is suppressed, whereby a shock suppressing effect becomes marked.

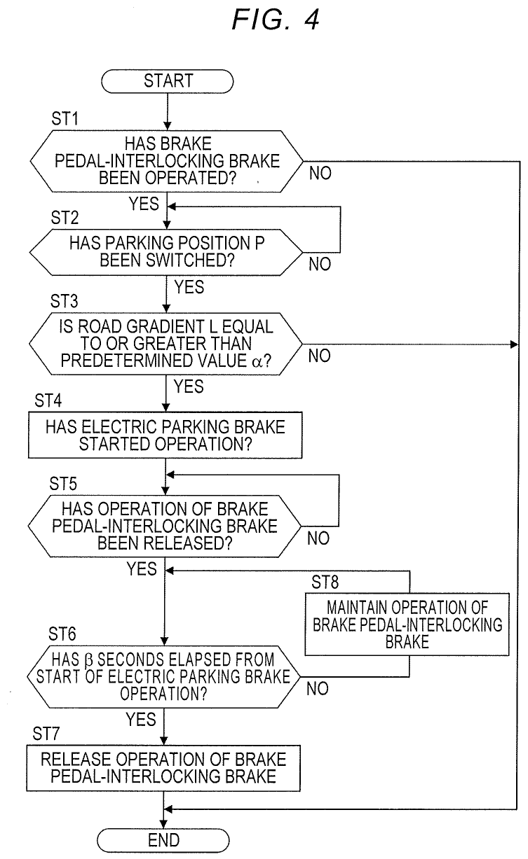

FIG. 4 is a flowchart illustrating principal parts of a control operation of the electronic control unit 100, that is, a control operation when the shifting operation position Psh can be switched to a parking position after the vehicle 10 has entered a stopped state or a very low-speed state through depression of the brake pedal 66. This flowchart is repeatedly performed while the vehicle is traveling.

First, in step ST1 (hereinafter, step is omitted) corresponding to the control function of the brake operation determining unit 110, it is determined whether the foot brake device 68 (the brake pedal interlocking brake) is operating through depression of the brake pedal 66. When the brake pedal 66 is not depressed, the determination result of ST1 is negative and this routine ends. When the brake pedal 66 is depressed and the foot brake device 68 operates, the determination result of ST1 is positive and it is determined whether the shifting operation position Psh has been switched to the parking position P in ST2 corresponding to the control function of the parking lock control unit 112. When the shifting operation position Psh has not been switched to the parking position P, the determination result of ST2 is negative and the process of ST2 is repeatedly performed until the shifting operation position Psh is switched to the parking position P. ON the other hand, when the shifting operation position Psh has been switched to the parking position P, the determination result of ST2 is positive and it is determined whether the road gradient L is equal to or greater than the predetermined value α in ST3 corresponding to the control function of the road gradient determining unit 114. When the road gradient L is less than the predetermined value α, the determination result of ST3 is negative and this routine ends. When the road gradient L is equal to or greater than the predetermined value cc, the determination result of ST3 is positive and operation of the electric parking brake 72 is started in ST4 corresponding to the control function of the brake control unit 116.

Subsequently, in ST5 corresponding to the control function of the brake operation determining unit 110, it is determined whether depression of the brake pedal 66 has been released. When depression of the brake pedal 66 is maintained, the determination result of ST5 is negative and the process of ST5 is repeatedly performed until depression of the brake pedal 66 is released. When depression of the brake pedal 66 has been released, the determination result of ST5 is positive and it is determined whether the predetermined time β has elapsed from starting of the operation of the electric parking brake 72 in ST6 corresponding to the control function of the elapsed time determining unit 118. When the predetermined time β has not elapsed from the starting of operation, the determination result of ST6 is negative, the operation of the foot brake device 68 is maintained regardless of whether depression of the brake pedal 66 has been released in ST8 corresponding to the control function of the brake control unit 116, and then ST6 is performed again. That is, the braking force applied to the vehicle wheels 28 by the foot brake device 68 is maintained. When it is determined in ST6 that the predetermined time β has elapsed from the starting of operation, the determination result of ST6 is positive and the operation of the foot brake device 68 is released in ST7 corresponding to the control function of the brake control unit 116. When the predetermined time β has elapsed and a driver continues to depress the brake pedal 66, the operation of the foot brake device 68 due to the driver's depression of the brake pedal 66 is maintained.

By executing control as described above, even when depression of the brake pedal 66 has been released immediately after the shifting operation position Psh has been switched to the parking position P, the braking force from the foot brake device 68 is maintained until a braking force is applied by the electric parking brake 72. Accordingly, rotation of the vehicle wheels 28 is curbed and torsion of the drive shafts 26 is curbed. Accordingly, when the shifting operation position Psh is switched to a non-parking position at the time of next starting of the vehicle, a shock due to release of the torsion of the drive shafts 26 is suppressed.

As described above, according to this embodiment, even when the operation of the foot brake device 68 has been rapidly released by a driver after the shifting operation position Psh has been switched to the parking position P, the braking force from the foot brake device 68 is maintained. Accordingly, rotation of the vehicle wheels 28 is curbed and torsion of the drive shafts 26 is curbed. Accordingly, when the shifting operation position Psh is switched from the parking position P to a non-parking position at the time of next starting of the vehicle, a shock which is generated due to the torsion of the drive shafts 26 is suppressed.

According to this embodiment, when the road gradient L is equal to or greater than the predetermined value α and the shifting operation position Psh is switched to the parking position P, the electric parking brake 72 operates. Accordingly, by operating the electric parking brake 72 on only the road gradient L on which torsion of the drive shafts 26 is likely to occur and not operating the electric parking brake 72 on the road gradient L on which torsion of the drive shafts 26 is not likely to occur, it is possible to decrease the number of operations of the electric parking brake 72 and to improve durability of the electric parking brake 72. By detecting the road gradient L from the acceleration G which is detected by the existing G sensor 92, it is not necessary to add a new sensor for detecting the road gradient L.

According to this embodiment, since the vehicle 10 is an electric vehicle, a shock due to the torsion of the drive shafts 26 is likely to increase in comparison with a vehicle including an engine when the shifting operation position Psh is switched to a non-parking position. Accordingly, a shock suppressing effect which is obtained by maintaining the operating state of the foot brake device 68 and curbing torsion of the drive shafts 26 becomes marked.

While an embodiment of the disclosure has been described above in detail with reference to the accompanying drawings, the disclosure can be applied to other aspects.

For example, in the above-mentioned embodiment, the vehicle 10 is an electric vehicle which is driven with a traveling motor MG but the disclosure is not limited to an electric vehicle. For example, the disclosure may be applied to a hybrid vehicle including an engine and an electric motor.

In the above-mentioned embodiment, the electric parking brake 72 operates when the road gradient L is equal to or greater than the predetermined value α, but the electric parking brake 72 may operate regardless of the value of the road gradient L.

In the above-mentioned embodiment, the road gradient L is estimated based on the vehicle longitudinal acceleration G which is detected by the G sensor 92, but the method of acquiring the road gradient L is not limited thereto. For example, the road gradient L may be directly detected using a horizontal level gauge. Alternatively, the road gradient L may be detected based on road information from a navigation system.

In the above-mentioned embodiment, in the configuration in which the electric parking brake 72 can be switched between operation and non-operation by a driver's manual operation, when the electric parking brake 72 is switched to non-operation and the shifting operation position Psh is switched to the parking position, the electric parking brake 72 may be set to operate in preference to a driver's manual operation.

In the above-mentioned embodiment, both the foot brake device 68 and the electric parking brake 72 are configured to apply a braking force to the vehicle wheels 28 by operating the common wheel brakes 75, but the foot brake device 68 and the electric parking brake 72 may include separate wheel brakes and apply a braking force by operating the separate wheel brakes.

The electric parking brake 72 is not limited to the aspects of the above-mentioned embodiment and can be appropriately modified as long as a braking force can be applied to the vehicle wheels 28 via an electric actuator. The foot brake device 68 is not limited to the aspects of the above-mentioned embodiment and can be appropriately applied to any structure as long as it can be operated by a driver's operation and operation thereof can be controlled by controlling a brake oil pressure. The parking lock mechanism 40 is not limited to the aspects of the above-mentioned embodiment and can be appropriately applied to any structure as long as it can curb rotation of the parking gear by causing the parking gear to engage with the parking pole.

The above-mentioned embodiment is only an example and the disclosure can be embodied in aspects including various modifications and improvements based on knowledge of those skilled in the art.

What is claimed is:

1. A control device for a vehicle, the vehicle including a first brake device that applies a braking force to vehicle wheels in response to a driver's operation of a brake, a second brake device that applies a braking force to the vehicle wheels through an electric actuator when a shifting operation position is switched to a parking position, and a parking lock mechanism that stops rotation of the vehicle wheels by stopping rotation of a parking gear interlocking with the vehicle wheels when the shifting operation position is switched to the parking position, the control device comprising
an electronic control unit configured to maintain an operating state of the first brake device until the braking force is applied to the vehicle wheels by the second brake device when the shifting operation position is switched to the parking position after the first brake device has been operated by the driver.

2. The control device for a vehicle according to claim 1, wherein the electronic control unit is configured to determine whether a predetermined time has elapsed from a time point at which operation of the second brake device has started and to maintain the operating state of the first brake device when the electronic control unit determines that the predetermined time has not elapsed from the time point at which the operation of the second brake device has started.

3. The control device for a vehicle according to claim 1, further comprising a road gradient detecting unit that detects a road gradient,
wherein the electronic control unit is configured to determine whether the detected road gradient is equal to or greater than a predetermined value and to operate the second brake device when the electronic control unit determines that the detected road gradient is equal to or greater than the predetermined value and the shifting operation position is switched to the parking position.

4. The control device for a vehicle according to claim 3, wherein the road gradient detecting unit is an acceleration sensor.

5. The control device for a vehicle according to claim 1, wherein the vehicle is an electric vehicle.

6. A vehicle comprising:
a first brake device that applies a braking force to vehicle wheels in response to a driver's operation of a brake;
a second brake device that applies a braking force to the vehicle wheels through an electric actuator when a shifting operation position is switched to a parking position;
a parking lock mechanism that stops rotation of the vehicle wheels by stopping rotation of a parking gear interlocking with the vehicle wheels when the shifting operation position is switched to the parking position; and
an electronic control unit configured to maintain an operating state of the first brake device until the braking force is applied to the vehicle wheels by the second brake device when the shifting operation position is switched to the parking position after the first brake device has been operated by the driver.
